(19) United States
(12) Patent Application Publication
(10) Pub. No.: US 2014/0095239 A1
(43) Pub. Date: Apr. 3, 2014

(54) SELF-SERVICE REGISTRATION AND QUEUE STATUS PRIORITIZATION

(71) Applicant: PASSPORT HEALTH COMMUNICATIONS, INC., Franklin, TN (US)

(72) Inventors: Lance Clifford Mansfield, Seattle, WA (US); Howard Bright, Kingston Springs, TN (US)

(73) Assignee: PASSPORT HEALTH COMMUNICATIONS, INC., Franklin, TN (US)

(21) Appl. No.: 14/039,093

(22) Filed: Sep. 27, 2013

Related U.S. Application Data
(60) Provisional application No. 61/708,280, filed on Oct. 1, 2012.

(51) Int. Cl. G06Q 10/06

(52) U.S. Cl. CPC G06Q 10/063114
USPC 705/7.15

(57) ABSTRACT

User self-service registration and queue status prioritization is provided. A user may check into an appointment via a web-interface prior to the appointment. He may enter and/or verify information such as demographic information, insurance information, payment information, financial information, etc. If there are any discrepancies in the information provided, the user may be alerted to the discrepancies, wherein he may be able to correct the discrepancies prior to arriving for the appointment. When an indication is received that the user has arrived for the appointment, the user may be elevated to the top of a queue and thereby minimizing wait time.

### CROSS-REFERENCE TO RELATED APPLICATIONS

The application claims priority to U.S. Provisional Patent Application No. 61/708,280 titled “Fast Pass” filed Oct. 1, 2012, the disclosure of which is hereby incorporated by reference in its entirety.

### BACKGROUND

Currently, when a user registers for an appointment with a service provider, for example, a healthcare provider, the user may register by checking in via a kiosk or with an administrative worker. During the process of registering for an appointment, the user may be required to provide information, such as demographic information, insurance information, payment information, etc. The information may be utilized for various processes which may be performed between the time when user data is received and when healthcare services are provided. The various processes may make up a patient access workflow and may include such processes as, but are not limited to, finding coverages (e.g., insurance eligibility and verification), verifying demographic data to help ensure that a user's demographic data is correct for insurance claims, billing statements, etc., checking payer compliance to help screen for payer medical necessity and precertification and to aid with accuracy in orders, coding and billing, estimating a payment amount, determining a user's financial situation to help mitigate the risk of late payments and possible need for collections later on, and collecting payment for services.

Providing user information can oftentimes be a time-consuming process and may lead to a longer wait time for an appointment or may require the user to arrive early to the appointment in order to provide the required information. If a service provider verifies user information on the front end and if there are any discrepancies, the user may be required to correct the discrepancies prior to receiving services. This also may result in a longer wait time. If a service provider does not verify user information on the front end and if there are any discrepancies, the service provider may incur additional operating costs in order to resolve any issues resulting from incorrect information.

It is with respect to these and other considerations that the present invention has been made.

### SUMMARY

Embodiments of the present invention provide user self-service registration and queue status prioritization. When a user chooses to receive services from a service provider (e.g., healthcare services from a healthcare service provider) embodiments may be utilized to allow the user to enter user data for registration processes prior to the user's appointment. The user may be alerted to any discrepancies, missing data, or a need for additional data, and may be provided with an opportunity to correct any incorrect information or provide any needed information prior to the appointment. If all issues are resolved prior to the appointment, when the user arrives for his appointment, the user may be prioritized in a queue to receive services. Accordingly, the user's wait time may be minimized.

### BRIEF DESCRIPTION OF DRAWINGS

FIG. 1 is a simplified block diagram of a high-level system architecture with which embodiments of the invention may be implemented.

FIG. 2 is a flow chart of a method for providing user self-service registration and queue status prioritization.

FIG. 3 is a simplified block diagram of a computing device with which embodiments of the present invention may be practiced.

### DETAILED DESCRIPTION

Embodiments of the present invention provide user self-service registration and queue status prioritization. User self-service registration and queue status prioritization is provided. A user may check into an appointment via a web-interface prior to the appointment. He may enter and/or verify information such as demographic information, insurance information, payment information, financial information, etc. If there are any discrepancies in the information provided, the user may be alerted to the discrepancies, wherein he may be able to correct the discrepancies prior to arriving for the appointment. When an indication is received that the user has arrived for the appointment, the user may be elevated to the top of a queue and thereby minimizing wait time.

These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents. Referring now to the drawings, in which like numerals refer to like elements throughout the several figures, embodiments of the present invention and an exemplary operating environment will be described.

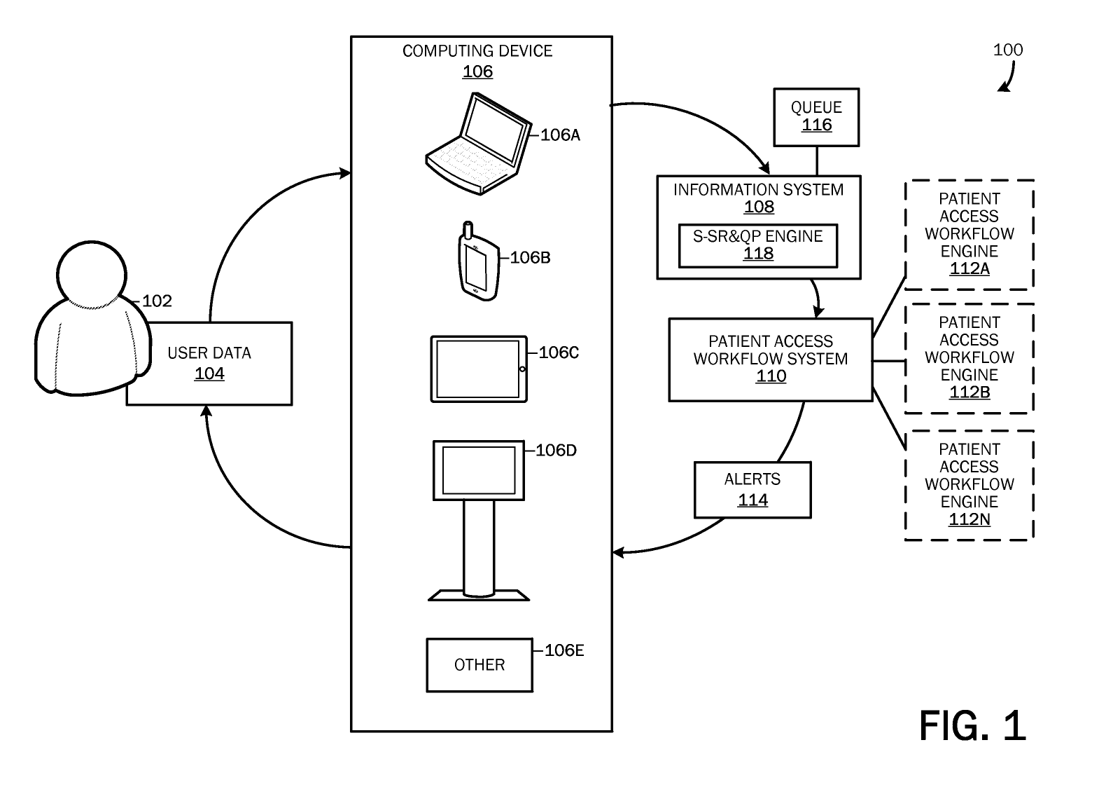

Referring now to FIG. 1, a simplified block diagram of a high-level system architecture 100 with which embodiments of the invention may be implemented is shown. Embodiments and examples may be described herein as relating to healthcare services transactions; however, as should be appreciated, embodiments are not limited to such and may be utilized in various types of environments comprising user registration. When an individual, such as a patient (herein referred to as a user 102), seeks services from a provider, such as healthcare services from a healthcare provider, various pieces of information associated with the individual may be provided for registration purposes. The information may be provided to an information system 108 associated with the provider. The information system 108 may comprise or may be in communication with a self-service registration and prioritization engine 118 operable to allow a user 102 to input user data 104 for registration. The self-service registration and prioritization engine 118 may also be operable to prioritize the user 102 in a queue 116 as will be described in greater detail below.

If the provider is a healthcare provider and the user is seeking healthcare services, the inputted information may include user data 104 such as demographics data (e.g., name, address, phone number(s), social security number, date of birth, gender, marital status, emergency contact information, employment status and details, student status and details, insurance information, etc.), admissions data, pre-registration data, coverage data, scheduling data, etc. If a guarantor of the individual's account is someone other than the individual, the information may also include data associated with the guarantor.

According to embodiments, the user 102 may utilize a computing device 106 to enter the user data 104. For example, the user 102 may utilize a computer 106A, a mobile phone 106B, a tablet device 106C, a kiosk 106D, or other type of computing device 106E. The computing device 106 may be located at the provider's facility, or may be located remotely. For example, the user 102 may utilize his home computer 106A, or if he is on the go, may utilize his mobile phone 106B or tablet device 106C to enter his user data 104 via a web interface. Alternatively, the user 102 may utilize a kiosk 106D or other type of computing device 106E located at the provider's facility to enter his user data 104. The self-service registration and prioritization engine 118 may be accessed via the computing device 106 via a web interface.

The user data 104 may be communicated with a registration workflow system 110 (e.g., a patient access workflow system), which may be integrated with the information system 108, or may be a separate system. The registration workflow system 110 may be comprised of or in communication with one or more workflow engines 112 operable to perform various registration processes. For example, in a healthcare system, the information may be used for such processes as demographic information verification, insurance eligibility verification, estimation of services, payment, pre-certification, financial clearance, charity application, etc. During the one or more registration processes, the user data 104 may be verified using pre-established rules and workflows that may be defined by the service provider. If a potential problem is discovered, such as missing, discrepant, or erroneous user data 104, if additional user data 104 or other data is needed, or if an issue is detected during the one or more registration processes, an alert 114 may be created and communicated with the user 102. According to an embodiment, an alert may be provided to the user 102 if additional data can be provided by the user 102 or if an error can be corrected by the user 102. When any additional user data 104 or other data is provided and/or when any missing, discrepant, or erroneous user data 104 is corrected, the alert 114 may be cleared. When a user 102 completes user data 104 entry and after he/she resolves any alerts 114, a status of the user 102 may be elevated to a registered status.

According to embodiments, when the user 102 arrives to receive services from the provider (or is within a predetermined distance from the provider), an indication of the arrival of the user 102 may be communicated with the information system 108. According to an embodiment, the indication of arrival may be communicated manually, for example, by the user 102 manually checking in via a kiosk 106D or via a mobile phone 106B, tablet device 106C, or other computing device 106E upon arrival. According to another embodiment, the indication of arrival may be communicated automatically via the user's computing device 106, such as the user's mobile phone 106A or tablet device 106C. The indication of arrival may be an automatic detection that the user 102 is at or within close proximity of the service provider via a presence determining system, for example, a global positioning system (GPS).

When the indication of arrival of the user 102 is received and if the user's status is elevated to a registered status, the user 102 may be prioritized in a registration queue 116. Accordingly, the patient 102 may experience a shorter wait time and may be able to avoid having to fill out registration paperwork upon arriving at the provider's facility.

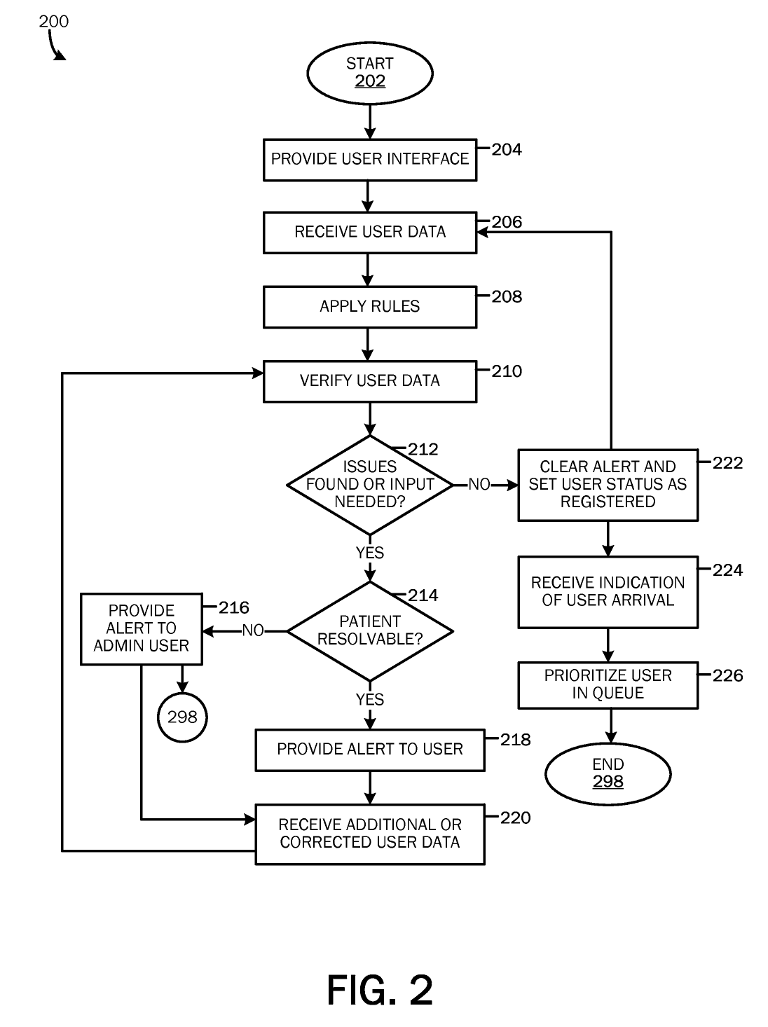

Having described a high-level system architecture 100, FIG. 2 is a flow chart showing one embodiment of a method 200 for providing user self-service registration and queue status prioritization. The method 200 starts at OPERATION 202. The method 200 may begin when a user 102 seeks services from a provider, for example, a patient seeking healthcare services from a healthcare service provider. At OPERATION 204, a user interface may be provided via a computing device 106 to input user data 104.

OPERATION 206, the user data 104 is received. The user data 104 may include, but is not limited to, demographic information, insurance information, payment information, financial information, electronically signed consent forms, etc. According to an embodiment, the user 102 may be able to capture and send an image of identification data, such as an insurance card and driver license.

The method 200 proceeds to OPERATION 208, where various rules may be applied. For example, the various rules may define which registration processes may need to be performed, what pieces user data 104 may need to be provided, etc.

The method 200 may proceed to OPERATION 210 where one or more registration processes, such as demographic information verification, insurance eligibility verification, estimation of services, payment, pre-certification, financial clearance, charity application, etc., may be performed, and the user data 104 may be verified.

At DECISION OPERATION 212, a determination may be made as to whether any potential problems are discovered, such as missing, discrepant, or erroneous user data 104, if additional user data 104 is needed, or if an issue is detected during the one or more registration processes. If any missing, discrepant, or erroneous user data 104 is discovered, if additional user data 104 is needed, or if an issue is detected, the method 200 may proceed to DECISION OPERATION 214, where a determination may be made as to whether the user 102 may be able to resolve the potential problem. For example, if a determination is made at DECISION OPERATION 212 that the user 102 may need to provide additional user data 104, such as a signed consent form or an image of the user's insurance card, a determination may be made at DECISION OPERATION 214 that the user 102 may be able to provide the additional user data 104. As another example, a determination may be made that the user 102 is eligible for charity care. Accordingly, additional information may be needed to enroll the user 102 for charity care.

If a determination is made at DECISION OPERATION 214 that the user 102 may not be able to resolve the potential problem or issue that was discovered, at OPERATION 216, an alert 114 may be communicated with an administrative user. The administrative user may then resolve the issue if he/she is able to, which may entail receiving additional or corrected user data 104 (220).

Alternatively, if a determination is made at DECISION OPERATION 214 that the user 102 may be able to resolve the potential problem or issue that was discovered, an alert 114 may be communicated with user 102 at OPERATION 218. According to embodiments, the alert 114 may be provided via various methods. For example, a message may be displayed on a screen of the computing device 106, a call may be made to the user 102, a text message may be sent to the user 102, an email message may be sent to the user 102, etc. The alert 114 may indicate the one or more issue(s) that need to be resolved.

Upon receiving the alert 114, at OPERATION 220, the user 102 may provide additional or missing user data 104 or correct any discrepant or erroneous information. As an example, an alert 114 may be communicated to the user 102 if a social security number entered by the user 102 does not match the social security number associated with his insurance information, for example, as discovered via an insurance eligibility verification. If the social security number entered by the user 102 was incorrectly entered, he may correct the erroneous information. As another example, if it is determined that the user's 102 insurance information is invalid, the user 102 may be alerted and accordingly, the user 102 may, for example, provide corrected information via a web interface, call the service provider and provide his correct insurance information, or take a picture of his insurance card and email it to the service provider. The user data 104 may then be corrected in the information system 108.

The method 200 may then return to OPERATION 210, where the additional or corrected user data 104 may be verified. If no potential problems or issues are discovered at DECISION OPERATION 212, the method 200 may proceed to OPERATION 222, where the alert 114 may be cleared, and the user's status may be set as registered.

At OPERATION 224, an indication of the user's arrival may be received. The indication may be provided via various methods. According to an embodiment, the indication of arrival may be a manual selection made by the user 102 or by an administrative user. For example, the user 102 may check-in manually with an administrative worker, may scan a bar code, or check in via a kiosk 106D to provide an indication of arrival. The bar code may be provided to the user 102 via a web interface upon receiving a registered status. For example, the bar code may be displayed on the user's mobile phone 106B or tablet device 106C or printed out and scanned via a bar code reader at the service provider facility. As another example, the user 102 may send a text message from his mobile phone 106B or tablet device 106C indicating his arrival. As another example, the user 102 may utilize a web interface via his computer 106A, mobile phone 106B, tablet device 106C, or other computing device 106E to selectively indicate that he is physically present at the service provider location.

According to another embodiment, the indication of arrival may be communicated automatically via the user's computing device 106, such as the user's mobile phone 106A or tablet device 106C. The indication of arrival may be an automatic detection that the user 102 is at or within close proximity of the service provider via a presence determining system, for example, a global positioning system (GPS).

The method 200 may then proceed to OPERATION 226, where the user 102 may be prioritized in a queue 116 for his service appointment. That is, an indication is made that the user's information (user data 104) has been entered and verified, is cleared for receiving services, and is physically present at the service provider facility. Accordingly, the user may skip a registration process at the service provider and be added to the queue 116 to receive services, for example, healthcare services. The method 200 ends at OPERATION 298.

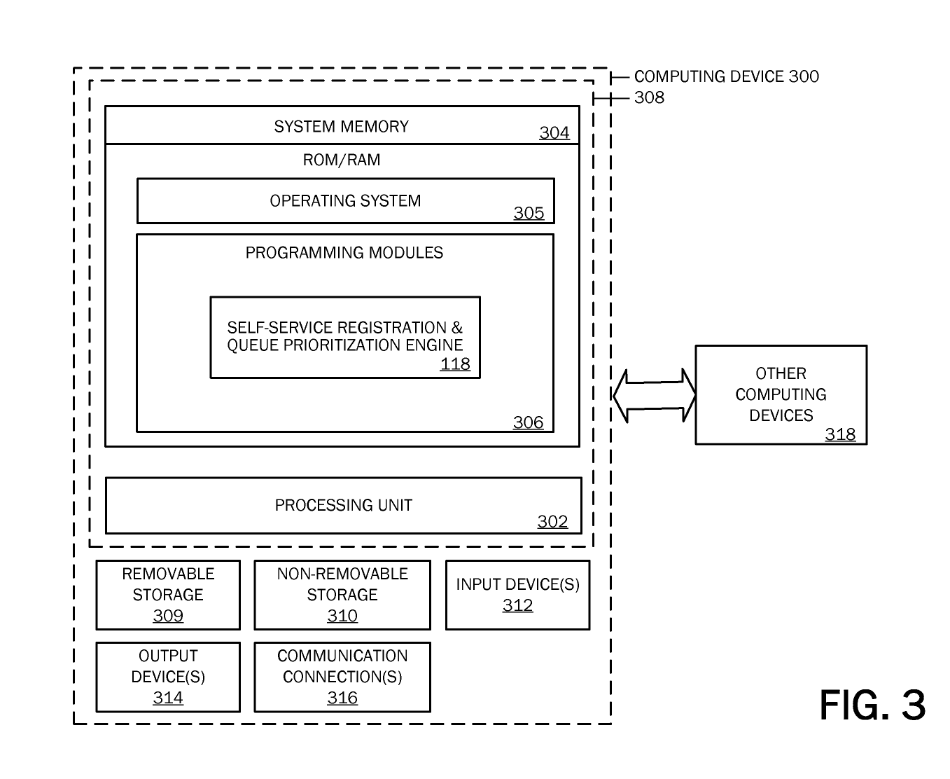

Embodiments of the invention may be implemented via local and remote computing and data storage systems. Such memory storage and processing units may be implemented in a computing device, such as computing device 300 of FIG. 3. Any suitable combination of hardware, software, or firmware may be used to implement the memory storage and processing unit. For example, the memory storage and processing unit may be implemented with computing device 300 or any other computing devices 318, in combination with computing device 300, wherein functionality may be brought together over a network in a distributed computing environment, for example, an intranet or the Internet, to perform the functions as described herein. Such systems, devices, and processors (as described herein) are examples and other systems, devices, and processors may comprise the aforementioned memory storage and processing unit, consistent with embodiments of the invention.

With reference to FIG. 3, a system consistent with embodiments of the invention may include one or more computing devices, such as computing device 300. The computing device 300 may include at least one processing unit 302 and a system memory 304. The system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a self-service registration and prioritization engine 118, wherein the self-service registration and prioritization engine 118 is a software application having sufficient computer-executable instructions, which when executed, performs functionalities as described herein. Operating system 305, for example, may be suitable for controlling computing device 300's operation. Furthermore, embodiments of the invention may be practiced in conjunction with a graphics library, other operating systems, or any other application program and is not limited to any particular application or system. This basic configuration is illustrated in FIG. 3 by those components within a dashed line 308. Computing device 300 may also include one or more input device(s) 312 (keyboard, mouse, pen, touch input device, etc.) and one or more output device(s) 314 (e.g., display, speakers, a printer, etc.).

Although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. The term computer-readable storage medium refers only to devices and articles of manufacture that store data and/or computer-executable instructions readable by a computing device. Computer-readable storage medium do not include communications media.

Further, the disclosed methods' stages may be modified in any manner, including by reordering stages and/or inserting or deleting stages, without departing from the invention.

The computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computing device 300 may also contain a communication connection 316 that may allow device 300 to communicate with other computing devices 318, such as over a network in a distributed computing environment, for example, an intranet or the Internet. Communication connection 316 is one example of communication media.

Program modules, such as the self-service registration and prioritization engine 118, may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable user electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system.

Embodiments of the present invention, for example, are described above with reference to block diagrams and/or operational illustrations of methods, systems, and computer program products according to embodiments of the invention. For example, FIGS. 1-3 and the described functions taking place with respect to each illustration may be considered steps in a process routine performed by one or more local or distributed computing systems. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

All rights including copyrights in the code included herein are vested in and the property of the Applicant. The Applicant retains and reserves all rights in the code included herein, and grants permission to reproduce the material only in connection with reproduction of the granted patent and for no other purpose.

We claim:

1. A method for providing user self-service registration and queue status prioritization, the method comprising:
providing a user interface for allowing a user to input user data;
receiving the user data;
determining if a correction or additional user data is needed;
if a correction or additional user data is not needed:
setting the user status as registered;
receiving an indication of arrival of the user; and
prioritizing the user in a queue.

2. The method of claim 1, wherein if a determination is made that a correction or additional user data is needed:
determining if the correction or additional user data is resolvable by the user;
if the correction or additional user data is resolvable by the user:
providing an alert;
receiving corrected or additional user data;
determining no correction or additional user data is needed;
clearing the alert;
setting the user status as registered;
receiving an indication of arrival of the user; and
prioritizing the user in a queue.

3. The method of claim 1, wherein determining if a correction or additional user data is needed further comprises verifying the user data via a registration workflow process.

4. The method of claim 3, wherein the registration workflow process comprises one or more of:
demographic information verification;
insurance eligibility verification;
estimation of services;
payment;
pre-certification;
financial clearance; or
charity application

5. The method of claim 1, wherein receiving an indication of arrival of the user comprises receiving an indication of arrival of the user via one of:
manually checking in;
scanning a bar code;
sending a text message; or
automatic presence determination.

6. The method of claim 1, wherein setting the user status as registered comprises providing the user with a bar code that may be scanned upon arrival at a service provider facility.

7. The method of claim 1, wherein receiving the user data comprises receiving an image capture of a driver license or insurance card.

8. A system for providing user self-service registration and queue status prioritization, the system comprising:
a memory storage; and
one or more processing units coupled to the memory storage, wherein the processing unit is operable to:
provide a user interface for allowing a user to input user data;
receive the user data;
determine if a correction or additional user data is needed;
if a correction or additional user data is not needed:
set the user status as registered;
receive an indication of arrival of the user; and
prioritize the user in a queue.

9. The system of claim 8, wherein if a determination is made that a correction or additional user data is needed, the one or more processors are operable to:
determining if the correction or additional user data is resolvable by the user;
if the correction or additional user data is resolvable by the user:
provide an alert;
receive corrected or additional user data;
determine no correction or additional user data is needed;
clear the alert;
set the user status as registered;
receive an indication of arrival of the user; and
prioritize the user in a queue.

10. The system of claim 8, wherein in determining if a correction or additional user data is needed, the one or more processors are further operable to communicate the user data with a registration workflow system and receive results from the registration workflow system.

11. The system of claim 10, wherein the one or more processors are operable to determine if a correction or additional user data is needed according to results of one or more of:
demographic information verification;
insurance eligibility verification;
estimation of services;
payment;
pre-certification;
financial clearance; or
charity application

12. The system of claim 8, wherein in receive an indication of arrival of the user, the one or more processors are operable to:
receive a manual checking in selection;
scan a bar code;
receive a text message; or
receive an indication of presence of the user via a presence determining system.

13. The system of claim 8, wherein in setting the user status as registered, the one or more processors are further operable to provide the user with a bar code that may be scanned upon arrival at a service provider facility.

14. The system of claim 8, wherein in receiving the user data, the one or more processors are further operable to receive an image capture of a driver license or insurance card.

15. A computer readable medium containing computer executable instructions which when executed by a computer perform a method of providing user self-service registration and queue status prioritization comprising:
providing a user interface for allowing a user to input user data;
receiving the user data;
determining if a correction or additional user data is needed;
if a correction or additional user data is not needed:
setting the user status as registered;
receiving an indication of arrival of the user; and
prioritizing the user in a queue; and
if a determination is made that a correction or additional user data is needed:
determining if the correction or additional user data is resolvable by the user;
if the correction or additional user data is resolvable by the user:
providing an alert;
receiving corrected or additional user data;
determining no correction or additional user data is needed;
clearing the alert;
setting the user status as registered;
receiving an indication of arrival of the user; and
prioritizing the user in a queue.

16. The computer readable medium of claim 15, wherein determining if a correction or additional user data is needed further comprises verifying the user data via a registration workflow process.

17. The computer readable medium of claim 16, wherein the registration workflow process comprises one or more of:
demographic information verification;
insurance eligibility verification;
estimation of services;
payment;
pre-certification;
financial clearance; or
charity application

18. The computer readable medium of claim 15, wherein receiving an indication of arrival of the user comprises receiving an indication of arrival of the user via one of:
manually checking in;
scanning a bar code;
sending a text message; or
automatic presence determination.

19. The computer readable medium of claim 15, wherein setting the user status as registered comprises providing the user with a bar code that may be scanned upon arrival at a service provider facility.

20. The computer readable medium of claim 15, wherein receiving the user data comprises receiving an image capture of a driver license or insurance card.
